(19) United States
(12) Patent Application Publication
(10) Pub. No.: US 2019/0100662 A1
(43) Pub. Date: Apr. 4, 2019

(54) INTUMESCENT COATING COMPOSITIONS CONTAINING EXPANSION AGENTS AND RELATED COATINGS AND METHODS

(71) Applicant: PPG Industries Ohio, Inc., Cleveland, OH (US)

(72) Inventors: Aditya Lakshmi Narasimha Raju Gottumukkala, Monroeville, PA (US); Seiko Sisco, Glenshaw, PA (US); Venkateshwarlu Kalsani, Gibsonia, PA (US); Christophe Grenier, Pittsburgh, PA (US); Ronnie Albertus Johannes Peskens, Haarlem (NL)

(73) Assignee: PPG Industries Ohio, Inc., Cleveland, OH (US)

(21) Appl. No.: 16/028,043

(22) Filed: Jul. 5, 2018

Related U.S. Application Data
(60) Provisional application No. 62/565,835, filed on Sep. 29, 2017.

(51) Int. Cl. C09D 5/18; C09D 7/40; C09D 163/00

(52) U.S. Cl. CPC C09D 5/185; C09D 163/00; C09D 7/69

(57) ABSTRACT

An intumescent coating composition includes a binder resin, an acid-generating agent, and an expansion agent. The expansion agent can be meso-lactide, a polylactide or other polyester, a polysulfone, a polycarbonate, a 1,1-di-activated vinyl compound, or an addition polymer of a 1,1-di-activated vinyl compound, or a combination of any thereof.

### CROSS REFERENCE TO RELATED APPLICATION

This application claims priority to U.S. Provisional Patent Application Ser. No. 62/565,835 filed Sep. 29, 2017, which is incorporated herein by reference.

### BACKGROUND OF THE INVENTION

Building construction, particularly commercial and industrial buildings, primarily utilize structural steel framework. Steel framed buildings can be susceptible to loss of structural integrity in a fire. This can occur when the temperature of the steel framework increases to a point where the steel “softens” and loses its load-bearing capacity, thereby compromising the structural integrity of the building. One way to address this issue is to insulate the steel. The degree of insulation affects the amount time required for the steel to heat up to the point where the structure becomes unstable. Intumescent coatings can be used on many substrates, including structural steel frameworks in buildings, to delay the heating effects of a fire. An intumescent coating slows the rate of temperature increase of the coated substrate in a fire, and thus increases the time before the substrate fails due to the heat generated by a fire.

Intumescent coatings produce gases upon heating. Intumescent coatings decompose at elevated temperatures to form a cellular carbonaceous char that expands into a foam by the release of the gases which become trapped within the char. The foamed char forms an insulating layer that protects the underlying substrate from heat damage. Intumescent coatings can be applied to surfaces that benefit from increased heat and fire resistance. Intumescent coatings are commonly used in the construction industry to provide increased fire resistance to building materials, particularly steel frameworks, by decreasing the heating rate of the materials and hence increasing the time required for the building materials to reach a critical failure temperature.

### SUMMARY OF THE INVENTION

The invention described in this specification relates to intumescent coating compositions comprising an expansion agent, such as, for example, a 1,1-di-activated vinyl compound or an addition polymer of a 1,1-di-activated vinyl compound. The invention described in this specification also relates to intumescent coatings formed from intumescent coating compositions comprising an expansion agent, and to substrates coated with the intumescent coatings. The invention described in this specification also relates to methods for protecting substrates with intumescent coatings formed from intumescent coating compositions comprising an expansion agent.

An intumescent coating composition comprises a binder resin, an acid-generating agent, and an expansion agent. The expansion agent comprises meso-lactide, polylactide, a polysulfone, a polycarbonate, a polyester, a 1,1-di-activated vinyl compound, or an addition polymer of a 1,1-di-activated vinyl compound, or a combination of any thereof. The intumescent coating composition can optionally comprise a carbon donor compound.

A two-component intumescent coating composition comprises (A) a binder component, and (B) a curing agent component. The binder component (A) comprises an epoxy-functional binder resin. The curing agent component (B) comprises an amino-functional resin and an expansion agent. The expansion agent comprises particles of an addition polymer of a 1,1-di-carbonyl vinyl compound. Component (A), or component (B), or both components (A) and (B), further comprise an acid-generating agent. The coating composition comprises a 100% solids formulation that does not comprise a solvent or an aqueous carrier. The two-component intumescent coating composition can optionally comprise a carbon donor compound, for example, in the binder component (A).

It is understood that the invention described in this specification is not necessarily limited to the examples summarized in this Summary.

### BRIEF DESCRIPTION OF THE DRAWINGS

Various features and characteristics of the invention described in this specification may be better understood by reference to the accompanying figures, in which:

FIG. 1 is a plot of thermogravimetric analysis/mass spectrometry (TGA-MS) data for an expansion agent powder comprising an addition polymer of diethyl methylene malonate showing the release of carbon dioxide gas as the powder is heated to decomposition.

The reader will appreciate the foregoing features and characteristics, as well as others, upon considering the following detailed description of the invention according to this specification.

### DETAILED DESCRIPTION OF THE INVENTION

As used in this specification, particularly in connection with coating layers or films, the terms “on,” “onto,” “over,” and variants thereof (e.g., “applied over,” “formed over,” “deposited over,” “provided over,” “located over,” and the like), mean applied, formed, deposited, provided, or otherwise located over a surface of a substrate, but not necessarily in contact with the surface of the substrate. For example, a coating layer “applied over” a substrate does not preclude the presence of one or more other coating layers of the same or different composition located between the applied coating layer and the substrate. Likewise, a second coating layer “applied over” a first coating layer does not preclude the presence of one or more other coating layers of the same or different composition located between the applied second coating layer and the applied first coating layer.

As used in this specification, the terms “polymer” and “polymeric” means prepolymers, oligomers, and both homopolymers and copolymers. As used in this specification, “prepolymer” means a polymer precursor capable of further reactions or polymerization by one or more reactive groups to form a higher molecular mass or cross-linked state.

As used in this specification, the prefix “poly” refers to two or more. For example, a “polyfunctional” molecule (whether a polymer, monomer, or other compound) comprises two or more reactive functional groups such as epoxy groups, amine groups, and the like. More specifically, “polyepoxide” means a compound comprising two or more epoxy (i.e., glycidyl) groups, “polyamine” means a compound comprising two or more amine groups, and “polyol” means a compound comprising two or more hydroxyl groups.

A polyfunctional compound such as a polyepoxide, polyamine, or polyol, may be a polymer, but does not have to be a polymer, and may comprise, for example, non-polymeric compounds. A polymeric polyepoxide, polymeric polyamine, or polymeric polyol, for example, respectively comprises two or more pendant and/or terminal epoxy, amine, or hydroxyl groups on the polymer molecules. A “pendant group” refers to a group that comprises an offshoot from the side of a polymer backbone and which does not comprise part of the polymer backbone, whereas “terminal group” refers to a group on an end of a polymer backbone and which comprises part of the polymer backbone.

Additionally, the terms polyepoxide, polyamine, polyol, and the like may encompass compounds comprising combinations of different types of functional groups. For example, a compound comprising two or more hydroxyl groups and two or more epoxy groups may be referred to as a polyol, a polyepoxide, or a polyol/polyepoxide. Furthermore, polyepoxide, polyamine, polyol, and like compounds may comprise either or both the neutral functional groups (epoxy, amine, hydroxyl, etc.) and/or a salt of an ionized form of the functional group (e.g., alkoxide salts, ammonium salts, and the like).

As used in this specification, the term “1,1-di-activated vinyl compound” means a compound comprising a vinyl group having two electron withdrawing groups (EWG) covalently bonded to one of the π-bonded carbons and no substituents covalently bonded to the other π-bonded carbon (i.e., -EWG-C(═CH₂)-EWG-), wherein the electron withdrawing groups independently comprise halogen groups, haloalkyl groups, carbonyl-containing groups (e.g., esters, amides, aldehydes, ketones, acyl halides, carboxylic/carboxylate groups), cyano groups, sulfonate groups, ammonium groups, quaternary amine groups, or nitro groups. The term “1,1-di-carbonyl vinyl compound” means a “1,1-di-activated vinyl compound” in which the EWGs are carbonyl-containing groups (e.g., esters, amides, aldehydes, ketones, acyl halides, carboxylic/carboxylate groups). Likewise, the terms “1,1-di-sulfonate vinyl compound,” “1,1-di-ammonium vinyl compound,” and the like, means a “1,1-di-activated vinyl compound” in which the EWGs are respectively sulfonate groups, ammonium groups, and the like.

The term “multifunctional form” means a 1,1-di-activated vinyl compound comprising two or more 1,1-di-activated vinyl groups covalently bonded in one molecule. For instance, a dialkyl methylene malonate is an example of a 1,1-di-activated vinyl compound, and a transesterification adduct of a dialkyl methylene malonate and a polyol is an example of a multifunctional form of a dialkyl methylene malonate.

To “intumesce” means to char and expand. When exposed to heat from a fire, for example, components in an intumescent coating chemically react to produce gases and a cellular carbonaceous char that expands into a foam when the gases become trapped within the char. Intumescent coatings thus form a relatively thick, non-flammable, and thermally insulative foam barrier on the surfaces of coated substrates exposed to fire and/or relatively high heat.

Intumescent coating compositions generally comprise a binder resin, an acid-generating agent which thermally decomposes at elevated temperatures (e.g., greater than 200° C.) and produces an acid that reacts with the carbon donor compound to produce a carbonaceous char, and an expansion agent that decomposes at elevated temperatures (e.g., greater than 200° C.) and produces a gas that volumetrically expands the carbonaceous char and produces a carbonaceous foam. Intumescent coating compositions can optionally comprise a carbon donor compound which functions as a charring agent, or, in some cases, the binder resin can function as a carbon donor compound. Intumescent coating compositions can be thermosetting compositions that further comprise a curing agent which reacts with the binder resin to crosslink the binder resin and cure the coating composition. In some cases the curing agent can comprise a polymeric compound or resin that is reactive with a binder resin to form crosslinks and cure the coating composition. Intumescent coating compositions can be applied over substrates and cured to produce intumescent coatings.

As used in this specification, the terms “cure” and “curing” refer to the chemical crosslinking of components in a coating composition applied as a coating layer over a substrate. Accordingly, the terms “cure” and “curing” do not encompass solely physical drying of coating compositions through solvent or carrier evaporation. In this regard, the term “cured,” as used in this specification, refers to the condition of a coating layer in which at least one of the components of the coating composition forming the layer has chemically reacted to form new covalent bonds in the coating layer (e.g., new covalent bonds formed between a binder resin and a curing agent).

When intumescent coatings are exposed to fire or heat, and, as a result, the temperature of the intumescent coatings exceeds 200° C., for example, the acid-generating agent decomposes to provide an acid. The carbon donor compound reacts with the acid to form a carbonaceous char. For example, an ammonium polyphosphate acid-generating agent decomposes at about 240° C. to form ammonia and phosphoric acid. The phosphoric acid can function as an acid for dehydration reactions of organic polyol compounds such as starch, cellulose, non-polymeric sugars (e.g., glucose, fructose, sucrose, and the like), pentaerythritol, dipentaerythritol, or tripentaerythritol, or combinations of any thereof, which function as carbon donor compounds. The phosphoric acid reacts with the hydroxyl groups to form heat-unstable phosphate esters, which decompose to release carbon dioxide and regenerate the phosphoric acid. The dehydrated carbon donor compound forms the carbonaceous char, and the carbon dioxide expands the char into a foam. The expansion agent likewise decomposes at elevated temperatures (e.g., greater than 200° C.) and produces additional gas that volumetrically expands the carbonaceous char and produces the carbonaceous foam.

An intumescent coating composition can comprise a binder resin; a carbon donor compound; an acid-generating agent; and an expansion agent comprising polylactide, a polysulfone, a polycarbonate, a polyester, or an addition polymer of a 1,1-di-activated vinyl compound, or a combination of any thereof. The intumescent coating composition can be solvent-based, water-based, or the coating composition can comprise a 100% solids formulation that does not comprise a volatile solvent or aqueous carrier.

The binder resin can comprise a thermosetting compound, for example, a thermosetting polymer or a mixture of two or more different thermosetting polymers and/or compounds. The binder resin can comprise, for example, one or more of the following cross-linkable functional groups: acrylates, epoxy, amine, ester, vinyl, vinyl ester, amide, urethane, mercaptan, carboxylic acid, acryloyl, methacyloyl, isocyanate, alkoxysilyl, anhydride, hydroxyl, alkoxy, or thiol groups. For example, the binder resin can comprise an epoxy-functional resin (i.e., a polyepoxide resin). An epoxy-functional resin can have a number average molecular weight (Mn) in the range of 300 to 6,000 g/mol, or any sub-range subsumed therein, such as, for example, 300-3,000 g/mol; 300-1,000 g/mol; or 300-500 g/mol. An epoxy-functional binder resin can have an epoxy equivalent weight in the range of 100 to 5,000 grams/equivalent, or any sub-range subsumed therein, such as, for example, 100-1,000 g/eq.; 100-500 g/eq.; or 100-200 g/eq.

Suitable epoxy-functional resins include (i) polyglycidyl ethers derived from polyhydric alcohols such as ethylene glycol; diethylene glycol; triethylene glycol; 1,2-propylene glycol; 1,4-butylene glycol; 1,5-pentanediol; 1,2,6-hexanetriol; glycerol; trimethylolpropane; bisphenol-A (a condensation product of acetone and phenol); bisphenol-F (a condensation product of phenol and formaldehyde); hydrogenated bisphenol-A; or hydrogenated bisphenol-F; (ii) polyglycidyl ethers of polycarboxylic acids, formed by the reaction of an epoxy compound such as epichlorohydrin with an aliphatic or aromatic polycarboxylic acid such as oxalic acid; succinic acid; glutaric acid; terephthalic acid; 2,6-napthalene dicarboxylic acid; or dimerised linoleic acid; (iii) epoxidized olefinically unsaturated alicyclic materials such as epoxy alicyclic ethers and esters; (iv) epoxy resins containing oxyalkylene groups; (v) epoxy novolac resins, which are prepared by reacting an epihalohydrin (e.g., epichlorohydrin) with a condensation product of an aldehyde with a monohydric or polyhydric phenol (e.g. phenolformaldehyde condensate); and (vi) combinations of any thereof. Preferably the binder resin comprises a di-epoxy-functional resin comprising a reaction product of bisphenol A and epichlorohydrin.

The intumescent coating composition can also comprise a curing agent for curing thermosetting binder resins. Suitable curing agents are not particularly limited, provided that the curing agents comprise functional groups that are capable of reacting with functional groups in the binder resin to produce covalent crosslinks and thereby cure the intumescent coating composition. For example, if the binder resin comprises an epoxy-functional resin, suitable curing agents include polymers and/or non-polymeric compounds comprising amine groups, amide groups, thiol groups, carboxylic acid groups, anhydride groups, and hydroxyl groups. Suitable examples include phenol resin curing agents, amino-functional (e.g., polyamide resin) curing agents, polythiol curing agents, polyanhydride curing agents, and polycarboxylic acid curing agents.

Examples of phenol resin curing agents include phenol novolac resins, bisphenol novolac resins, and poly p-vinylphenol resins. Examples of amino-functional curing agents include diethylene triamine; triethylene tetramine; tetraethylene pentamine; dicyandiamide; polyamido-amines; polyamide resins; ketimine compounds; isophorone diamine; m-xylene diamine; m-phenylene diamine; 1,3-bis(aminomethyl)cyclohexane; bis(4-aminocyclohexyl) methane; N-aminoethyl piperazine; 4,4′-diaminodiphenyl methane; 4,4′-diamino-3,3′-diethyl-diphenyl methane; and diaminodiphenyl sulfone. Examples of polycarboxylic acid curing agents include phthalic anhydride; tetrahydrophthalic anhydride; methyltetrahydrophthalic anhydride; 3,6-endomethylenetetrahydrophthalic anhydride; hexachloroendomethylenetetra-hydrophthalic anhydride; and methyl-3,6-endomethylenetetrahydrophthalic anhydride.

Other suitable binder resins include, for example, thermosetting polyfunctional polymeric resins that can be formulated in the intumescent coating compositions and crosslinked and cured with suitable curing agents. Such polyfunctional polymeric resins include polymeric resins comprising pendant and/or terminal hydroxyl, amine, mercapto, and/or carbamate groups, such as, for example, polyether polyols, polyester polyols, acrylic polyols, polycarbonate polyols, polyether polyamines, polyester polyamines, acrylic polyamines, polycarbonate polyamines, polyether polythiols, polyester polythiols, acrylic polythiols, polycarbonate polythiols, polyether polycarbamates, polyester polycarbamates, acrylic polycarbamates, polycarbonate polycarbamates, and combinations of any thereof. Additional polyfunctional polymeric resins that can be formulated in the coating compositions and crosslinked and cured with suitable curing agents include any polyfunctional polymeric resins that incorporate hydroxyl, amine, mercapto, or carbamate groups, or combinations of any thereof, including for example, polyester resins, polyurethane resins, polyurea resins, polyether resins, polythioether resins, polycarbonate resins, polycarbamate resins, phenolic resins, and aminoplast resins (urea-formaldehyde and/or melamine-formaldehyde).

The binder resin can comprise a self-crosslinkable binder resin for solvent-based intumescent coating compositions, such as the binder resins described in U.S. Patent Application No. 2017/0349776A1, which is incorporated-by-reference into this specification. The binder resin can comprise a vinyl binder resin for solvent-based intumescent coating compositions, such as the binder resins described in U.S. Patent Application No. 2017/0355844A1 (which is incorporated-by-reference into this specification). Other suitable binder resins are described in U.S. Patent Application Publication Nos. 2011/0311830 A1, 2015/0291810 A1, and 2016/0152841 A1, which are each incorporated-by-reference into this specification. An intumescent coating composition comprising a thermosetting binder resin in a 100% solids formulation that does not comprise a solvent or an aqueous carrier can further comprise a reactive diluent. For example, an intumescent coating composition comprising an epoxy-functional binder resin in a 100% solids formulation that does not comprise a solvent or an aqueous carrier can further comprise an epoxy-functional reactive diluent. Suitable epoxy-functional reactive diluents include non-polymeric di-functional epoxy compounds such as diglycidyl ethers of diol compounds (e.g., neopentyl glycol diglycidyl ether).

An intumescent coating composition comprising a thermosetting binder resin can also comprise a suitable curing agent. Because thermosetting binder resins and curing agents may spontaneously react to form covalent crosslinks, the binder resin and the curing agent can be formulated in separate packs of a two-component intumescent coating composition (e.g., separate containers or other packaging), wherein the two components are mixed together on site relatively close to the time of application onto a substrate. A binder component (A) can comprise the binder resin, and a curing agent component (B) can comprise the curing agent. The carbon donor compound, the acid-generating agent, and the expansion agent can be formulated in the binder component (A), or the curing agent component (B), or both components (A) and (B).

A two-component intumescent coating composition comprising a 100% solids formulation that does not comprise a solvent or an aqueous carrier can further comprise a reactive diluent in the binder component (A), or the curing agent component (B), or both components (A) and (B). For example, an intumescent coating composition can comprise a binder component (A) comprising an epoxy-functional binder resin and an epoxy-functional reactive diluent, as described above, and a curing agent component (B) comprising an amino-functional resin and an amino-functional reactive diluent. Suitable amino-functional reactive diluents include non-polymeric di-functional amino compounds such as aliphatic diamines (e.g., isophorone diamine). Reactive diluents in 100% solids formulations have lower viscosities than the corresponding resins with which the reactive diluents are formulated.

The carbon donor compound can comprise an organic polyhydroxy compound (i.e., an organic polyol) and/or expandable graphite. For example, the carbon donor compound can comprise pentaerythritol, dipentaerythritol, tripentaerythritol, a polysaccharide (e.g., starch, cellulose, glycogen, and the like), a disaccharide sugar (e.g., sucrose, lactose, maltose, and the like), a monosaccharide sugar (glucose, fructose, galactose, and the like), glycerol, or expandable graphite, or a combination of any thereof.

The acid-generating compound can comprise a source of phosphoric or sulfonic acid that is capable of producing the phosphoric or sulfonic acid upon exposure to heat, particularly at temperatures greater than 200° C. Examples of such sources include sodium phosphate, potassium phosphate (e.g., potassium tripolyphosphate), ammonium phosphate (e.g., ammonium polyphosphate (APP), monoammonium phosphate, diammonium phosphate), sodium sulfate, potassium sulfate, ammonium sulfate, magnesium sulfate, or para-toluene sulfonic acid, or a combination of any thereof. In some examples, the acid-generating compound comprises a phosphoric acid ester of a polyhydroxy compound, or an ammonium phosphate (e.g., APP), or an amine phosphate (e.g., melamine phosphate), or a combination of any thereof.

A particularly useful acid-generating compound is APP because APP yields phosphoric acid at temperatures generally below the decomposition temperatures of the carbon donor compounds described above. Thus, APP produces phosphoric acid that is readily available to participate in the charring reactions. APP compounds are polymeric phosphates, having P—O—P linkages, which may be represented by the formula: Hₙ₋ₘ₊₂(NH₄)ₘPnO₃ₘ₊₁, wherein the average value of n is at least about 10, the average value of m is a number up to n+2, and the ratio m/n is in the range of from about 0.7 to about 1.2. The values of n and m for any particular APP compound will be positive integers, while the average values of n and m for a mixture of APP compounds may each individually be a positive integer or a positive number which is not an integer. Particularly useful APP compounds in the intumescent coating compositions of the present invention include those having values of n>1000.

The acid-generating compound can also comprise boric acid or a source of boric acid that is capable of producing boric acid upon exposure to heat, particularly at temperatures greater than 200° C. The source of boric acid can comprise, for example, borate salts such as ammonium pentaborate, zinc borate, sodium borate, lithium borate, aluminum borate, magnesium borate, borosilicate compounds, and combinations of any thereof.

The expansion agent can comprise monomeric or polymeric compounds such as meso-lactide, polylactide, a polysulfone, a polycarbonate, a polyester, a 1,1-di-activated vinyl compound, or an addition polymer of a 1,1-di-activated vinyl compound, or a combination of any thereof. These polymers decompose at elevated temperatures (e.g., at temperatures greater than 200° C.) and produce gases such as carbon dioxide or sulfur dioxide.

Lactide (e.g., meso-lactide) is the cyclic diester of lactic acid. Lactide can be polymerized to produce polylactide (i.e., polylactic acid or poly(lactic acid)).

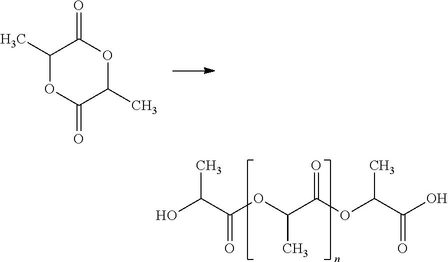

Polylactide thermally decomposes at temperatures of 200-300° C., producing carbon dioxide gas, which can expand the carbonaceous char produced from the carbon donor compound in intumescent coatings produced using the intumescent coating composition.

Polylactide is a polyester, which are polymers containing ester groups (—C(═O)—O—) in the polymer backbone. Other polyesters in addition to polylactide can be used as expansion agents that thermally decompose at elevated temperatures (e.g., above 200° C.) and produce carbon dioxide gas, which can expand the carbonaceous char produced from the carbon donor compound in intumescent coatings produced using the intumescent coating composition. The specific decomposition temperature will depend, at least in part, on the identity of the other constituent groups in the polymer backbone. Polyesters can be produced by ring-opening polymerization of lactide and lactone compounds (like polylactide and polycaprolactone), or by condensation reactions of diols and dicarboxylic acids, or by condensation reactions of hydroxy-functional carboxylic acids.

Polysulfones are polymers containing sulfonyl groups (—S(═O)₂—) in the polymer backbone:

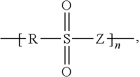

wherein R and Z represent hydrocarbon groups, optionally containing heteroatoms and/or other functional groups. Polysulfones can be produced, for example, by reacting diols and dihalo sulfones, thus forming polyethersulfones:

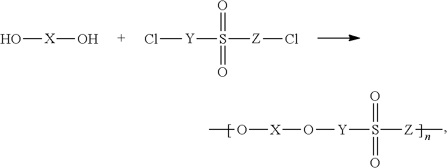

wherein X, Y, and Z represent hydrocarbon groups, optionally containing heteroatoms and/or other functional groups. Polysulfones thermally decompose at elevated temperatures (e.g., above 200° C.) and produce sulfur dioxide gas, which can expand the carbonaceous char produced from the carbon donor compound in intumescent coatings produced using the intumescent coating composition. The specific decomposition temperature will depend, at least in part, on the identity of the other constituent groups in the polymer backbone.

Polycarbonates are polymers containing carbonate groups (—O—C(═O)—O—) in the polymer backbone:

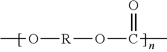

wherein R represents hydrocarbon groups, optionally containing heteroatoms and/or other functional groups. Polycarbonates can be produced, for example, by reacting diols and phosgene, or, alternatively, by transesterification of reactions between diols and diphenyl carbonate. Polycarbonates thermally decompose at elevated temperatures (e.g., above 200° C.) and produce carbon dioxide gas, which can expand the carbonaceous char produced from the carbon donor compound in intumescent coatings produced using the intumescent coating composition. The specific decomposition temperature will depend, at least in part, on the identity of the other constituent groups in the polymer backbone.

As described above, 1,1-di-activated vinyl compounds comprise a vinyl group having two electron withdrawing groups (EWG) covalently bonded to one of the π-bonded carbons and no substituents covalently bonded to the other π-bonded carbon. 1,1-di-activated vinyl compounds readily undergo anionic polymerization upon exposure to base compounds or otherwise under alkaline conditions to produce addition polymers. Addition polymerizable 1,1-di-activated vinyl compounds can comprise 1,1-di-carbonyl vinyl compounds, dihalo vinyl compounds, dihaloalkyl disubstituted vinyl compounds, or cyanoacrylate compounds, or multifunctional forms of any thereof, or combinations of any thereof. Examples of 1,1-di-activated vinyl compounds and multifunctional forms thereof that can be used as expansion agents and/or to produce addition polymers that function as expansion agents in the intumescent coating compositions are described in U.S. Pat. Nos. 8,609,885; 8,884,051; 9,108,914; 9,181,365; and 9,221,739, which are incorporated by reference into this specification. Additional examples of 1,1-di-activated vinyl compounds and multifunctional forms thereof that can be used as expansion agents and/or to produce addition polymers that function as expansion agents in the intumescent coating compositions are described in U.S. Publication Nos. 2014/0288230; 2014/0329980; and 2016/0068618, which are incorporated by reference into this specification.

The expansion agent can comprise a 1,1-di-carbonyl vinyl compound and/or an addition polymer of a 1,1-di-carbonyl vinyl compound comprising a methylene malonate. Methylene malonates are compounds having the general formula (I):

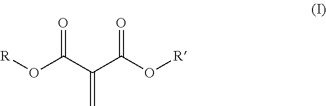

wherein R and R′ may be the same or different and may represent nearly any substituent or side-chain, such as substituted or unsubstituted alkyl or aryl groups. For example, the expansion agent can comprise an addition polymer of a dialkyl methylene malonate, a diaryl methylene malonate, a multifunctional form of a dialkyl methylene malonate, or a multifunctional form of a diaryl methylene malonate, or a combination of any thereof.

A multifunctional form of a methylene malonate can comprise a transesterification adduct of the methylene malonate and a polyol. A multifunctional form of a methylene malonate can thus have the general formula (II):

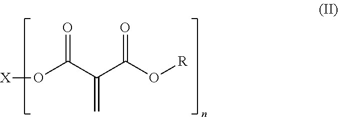

wherein n is greater than one, X is a polyol residue and each R may be the same or different, as described above. In some examples, a multifunctional form of a methylene malonate can comprise a transesterification adduct of the methylene malonate and a diol, and thus have the general formula (III):

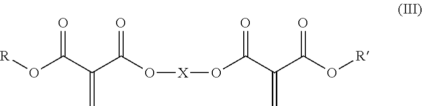

wherein X is a diol residue and R and R′ may be the same or different, as described above.

Polyols that are suitable for the production of a transesterification adduct with a methylene malonate include, for example, polymeric polyols (such as polyether polyols, polyester polyols, acrylic polyols, and polycarbonate polyols) and monomeric polyols (such as alkane polyols, including alkane diols such as 1,5-pentanediol and 1,6-hexanediol). Examples of transesterification adducts of methylene malonates and polyols that can be polymerized to produced addition polymers useful as the expansion agent in the intumescent coating compositions are described in U.S. Publication No. 2014/0329980 and U.S. Pat. No. 9,416,091, which are incorporated by reference herein.

The intumescent coating compositions can comprise an expansion agent comprising dimethyl methylene malonate (D3M), a multifunctional form of D3M, diethyl methylene malonate (DEMM), or a multifunctional form of DEMM, or an addition polymer of any thereof, or a combination of any thereof. The multifunctional forms of D3M or DEMM can comprise transesterification adducts of D3M or DEMM and a polyol, such as, for example, 1,5-pentanediol or 1,6-hexanediol. The intumescent coating compositions can comprise an expansion agent comprising an addition polymer of diethyl methylene malonate, an addition polymer of dimethyl methylene malonate, or an addition copolymer of diethyl methylene malonate and dimethyl methylene malonate, or a combination of any thereof.

An expansion agent comprising an addition polymer of a 1,1-di-activated vinyl compound, such as a 1,1-di-carbonyl vinyl compound like the methylene malonate compounds described above, can be produced by mixing a base activator compound into a volume of 1,1-di-activated vinyl compound or a mixture of two or more 1,1-di-activated vinyl compounds. As used in this specification, the term “base activator compound” means an electronegative compound or functional group capable of initiating the anionic polymerization of 1,1-di-activated vinyl compounds. Suitable base activator compounds include organic bases (e.g., amine-containing compounds and carboxylate salts), inorganic bases (e.g., hydroxide salts and carbonate salts), organometallic compounds, and combinations of any thereof. Suitable base activator compounds also include polymers comprising pendant and/or terminal amine, carboxylate salt, or other base functionality capable of initiating the anionic polymerization of 1,1-di-activated vinyl compounds.

The base activator compound can comprises a strong base (pH over 9), a moderate base (pH from 8-9), or a weak base (pH from over 7 to 8), or a combination of any thereof. The base activator compound can comprise, for example, sodium acetate; potassium acetate; acid salts of sodium, potassium, lithium, copper, or cobalt; tetrabutyl ammonium fluoride, chloride, or hydroxide; an amine, including primary, secondary, and tertiary amines; an amide; salts of polymer bound acids; benzoate salts; 2,4-pentanedionate salts; sorbate salts; propionate salts; secondary aliphatic amines; piperidene, piperazine, N-methylpiperazine, dibutylamine, morpholine, diethylamine, pyridine, triethylamine, tripropylamine, triethylenediamine, N,N-dimethylpiperazine, butylamine, pentylamine, hexylamine, heptylamine, nonylamine, decylamine; 1,4-diazabicyclo[2.2.2]octane (DABCO); 1,1′-iminobis-2-propanol (DTPA); 1,2-cyclohexaneamine; 1,3-cyclohexandimethanamine; 2-methylpentamethylenediamine; 3,3-iminodipropylamine; triacetone diamine (TAD); salts of amines with organic monocarboxylic acids; piperidine acetate; metal salt of a lower monocarboxylic acid; copper(II) acetate, cupric acetate monohydrate, potassium acetate, zinc acetate, zinc chloracetate, magnesium chloracetate, magnesium acetate; salts of acid containing polymers; salts of polyacrylic acid co-polymers; and combinations of any thereof.

The base activator compound can comprise a tertiary amine activator such as, for example, DABCO; 2-(dimethylamino)ethanol (DMAE/DMEA); 2-piperazin-1-ylethylamine; N,N,N′,N′-tetrakis(2-hydroxypropyl)ethylenediamine; 2-[2-(dimethylamino)ethoxy]ethanol; 1-[bis[3-(dimethylamino)propyl]amino]-2-propanol; N,N,N′,N″,N″-pentamethyldiethylenetriamine; N,N,N,N′-tetraethyl-1,3-propanediamine; N,N,N′,N′-tetramethyl-1,4-butanediamine; N,N,N′,N′-tetramethyl-1,6-hexanediamine; 1,4,8,11-tetramethyl-1,4,8,11-tetraazacyclotetradecane; 1,3,5-trimethylhexahydro-1,3,5-triazine; methyl dicocoamine; 1,8-diazabicycloundec-7-ene (DBU); 1,5 diazabicyclo-[4,3,0]-non-5-ene (DBN); 1,1,3,3-tetramethylguanidine; or combinations of any thereof.

Additional examples of base activator compounds and activation methods that can be used to produce expansion agents comprising an addition polymer of one or more 1,1-di-activated vinyl compounds are described in U.S. Pat. No. 9,181,365, which is incorporated by reference into this specification.

The expansion agent, which comprises meso-lactide, polylactide or other polyester, a polysulfone, a polycarbonate, a 1,1-di-activated vinyl compound, or an addition polymer of a 1,1-di-activated vinyl compound, or a combination of any thereof, can be in the form of polymer particles formulated into the intumescent coating composition. For example, a solid mass of addition polymer can be produced by mixing a base activator compound into a liquid volume of 1,1-di-activated vinyl compound or a mixture of two or more 1,1-di-activated vinyl compounds. The solid mass of addition polymer can be ground into a course powder. The course powder can then be further ground to a target average particle size. The expansion agent particles can be ground to a target average particle size using an air classification mill, for example. The expansion agent particles can have an average particle size of 0.1-100 micrometers, or any sub-range subsumed therein, such as, for example, 1-100 μm, 10-100 μm, 25-50 μm, or 35-40 μm. The average particle size of the expansion agent particles can be measured using sieve analysis, air elutriation analysis, photoanalysis (optical granulometry), or laser diffraction methods, for example.

The expansion agent, which comprises polylactide or other polyester, a polysulfone, a polycarbonate, or an addition polymer of a 1,1-di-activated vinyl compound, or a combination of any thereof, can be in the form of a resin incorporated into the intumescent coating compositions.

An expansion agent comprising a 1,1-di-activated vinyl compound or an addition polymer of a 1,1-di-activated vinyl compound, particularly a 1,1-di-carbonyl vinyl compound like the methylene malonate compounds described above, thermally decomposes at elevated temperatures (e.g., above 200° C.) and produces carbon dioxide gas, which can expand the carbonaceous char produced from the carbon donor compound in intumescent coatings produced using the intumescent coating composition. Without intending to be bound by any theory, it is believed that the pendant di-carbonyl groups (e.g., pendant diester groups) in addition polymers of 1,1-di-carbonyl vinyl compounds off-gas as carbon dioxide through a Krapcho elimination mechanism when the addition polymers are heated to elevated temperatures (e.g., above 200° C.).

The intumescent coating composition can comprise, for example, 5-25% of a binder resin; 5-15% of a carbon donor compound; 5-25% of a curing agent; 25-50% of an acid-generating agent; and 5-25% of an expansion agent, based on the total solids weight of the intumescent coating composition. The intumescent coating composition can comprise 5-25% of a binder resin, or any sub-range subsumed therein, such as, for example, 10-15%. The intumescent coating composition can comprise 5-15% of a carbon donor compound, or any sub-range subsumed therein, such as, for example, 5-10%. The intumescent coating composition can comprise 5-25% of a curing agent, or any sub-range subsumed therein, such as, for example, 15-20%. The intumescent coating composition can comprise 25-50% of an acid-generating agent, or any sub-range subsumed therein, such as, for example, 30-35%. The intumescent coating composition can comprise 5-25% of an expansion agent, or any sub-range subsumed therein, such as, for example, 5-10%.

In addition to the expansion agents described above, the intumescent coating composition can optionally further comprise an amine-functional expansion agent that decomposes to produce ammonia gas at elevated temperatures (e.g., greater than 200° C.). Ammonia-producing expansion agents comprise nitrogen-containing compounds such as glycine, melamine, melamine salts, melamine derivatives, urea, urea derivatives, dicyandiamide, guanidine, and isocyanurate derivatives.

Melamine has the following chemical structure:

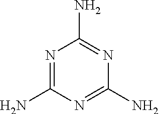

Melamine derivatives include for example melamine formaldehyde, methylolated melamine, hexamethoxymethylmelamine, melamine monophosphate, di-melamine phosphate, melamine biphosphate, melamine polyphosphate, melamine pyrophosphate, melamine cyanurate, melamine borate, melam (N2-(4,6-diamino-1,3,5-triazin-2-yl)-1,3,5-triazine-2,4,6-triamine), melem (2,5,8-triamino-1,3,4,6,7,9,9b-heptaazaphenalene), and melon (poly[8-amino-1,3,4,6,7,9,9b-heptaazaphenalene-2,5-diyl)imino).

Urea derivatives include, for example, N-alkylureas such as methyl urea; N,N′-dialkylureas such as dimethylurea; and N,N,N′-trialkylureas such as timethylurea; guanylurea; guanylurea phosphate; formamide amino urea; guanylurea phosphate; 1,3-diamino urea; biurea; and the like.

Isocyanurate derivatives comprise at least one isocyanurate ring having the following structure:

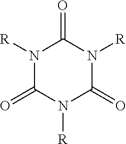

wherein each R group is independently a linear, branched, or cyclic alkyl or alkenyl group, optionally substituted with heteroatoms such as O, N, and S, and/or functional groups such as hydroxyl, epoxy, halide (Cl, Br, I), and/or an isocyanate groups. An example is tris-(2-hydroxyethyl)isocyanurate (THEIC):

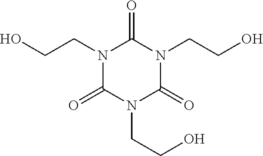 [SMILES: O=c1n(CCO)c(=O)n(CCO)c(=O)n1CCO]

The intumescent coating composition may also comprise accelerator compounds, which increase the curing reaction rate between an epoxy binder resin and an amino-functional curing agent. Examples of accelerator compounds include alcohols, phenols, carboxylic acids, sulfonic acids, and salts, and combinations of any thereof.

Alcohol accelerator compounds include ethanol, 1-propanol, 2-proanol, 1-butanol, 2-butanol, t-butanol, benzyl alcohol, furfuryl alcohol, propanediol, butanediol, glycerol triethanolamine, tri-isopropanolamine, dimethylaminoethanol, and other monhydric alcohols, polyhydric alcohols, and hydroxy-functional tertiary amines; and combinations of any thereof.

Phenol-based accelerator compounds include phenol; 2-chlorophenol; 4-chlorophenol; 2,4-dichlorophenol; 2,4,6-trichlorophenol; 2-nitrophenol; 4-nitrophenol; 2,4-dinitrophenol; 2,4,6-trinitrophenol; 2,4,6-Tri-(dimethylaminomethyl)-phenol; 4-cyanophenol; o-cresol; m-cresol; p-cresol; 4-ethylphenol; 4-isopropylphenol; 2,4-dimethylphenol; 3,5-dimethylphenol; nonyl phenol; eugenol; isoeugenol; cardanol; 2,2′-dihydroxybiphenyl; 2,4′-dihydroxybiphenyl; 4,4′-dihydroxybiphenol; bisphenol A; bisphenol F; catechol; 4-t-butyl catechol; resorcinol; 4-hexylresorcinol; orcinol; hydroquinone; naphthalenediol; anthracenediol; biphenylenediol; phloroglucinol; phloroglucide; calixarene; and poly(4-vinylphenol); and combinations of any thereof.

Carboxylic acid accelerator compounds include alkyl carboxylic acids such as acetic acid, propanoic acid, butyric acid, lactic acid, and phenyl acetic acid; dibasic acids or their monoesters such as malonic acid, oxalic acid, maleic acid, and fumaric acid; and aromatic acids such as benzoic acid, 4-t-butyl benzoic acid, salicylic acid, 3,5-dichlorosalicylic acid, and 4-nitrobenzoic acid; and combinations of any thereof.

Sulfonic acid accelerator compounds include alkyl sulfonic acid such as methanesulfonic acid; aromatic sulfonic acids such as p-toluenesulfonic acid, and 4-dodecylbenzenesulphonic acid; and polyhydric sulfonic acids such as naphthalene disulfonic acid, and di-nonyl naphthalene disulfonic acid.

The intumescent coating composition can also contain other optional components such as, for example, inorganic nucleating agents, rheology modifiers, inorganic filler particles, char reinforcing agents (e.g., fibers such as ceramic fibers, glass fibers, carbon fibers, silica fibers, and the like), flame retardants, liquid carriers (i.e., solvents, dispersants, surfactants, emulsifiers, diluents, and the like), colorants (e.g., dyes or pigments such as carbon black), glass microspheres, hollow glass microspheres, plasticizers, stabilizers, antibacterial agents, anti-mold agents, char promoters, fluxing aids, and leveling agents.

Inorganic nucleating agents can be included in the intumescent coating composition to promote char formation and increase the thermal resistance properties and stability of the char during a fire. Examples of inorganic nucleating agents include titanium dioxide, zinc oxide, aluminum oxide, iron oxides, carbon black silica, silicates, cerium oxide, lanthanum oxide, and zirconium oxide, calcium carbonite, talc, wollastonite, mica, bentonite clay, and combinations of any thereof. A nucleating agent such as titanium dioxide, which is also a pigment, can provide opacity and/or color to the intumescent coating.

Rheology modifiers include, for example, bentonite clays, hectorite clays, attapulgite clays, micronized amide waxes, wax thixotropes based on castor oil and castor oil derivatives, fumed silica, and combinations of any thereof.

Inorganic filler particles and char reinforcing agents include, for example, zinc borate, zinc stannate, zinc hydroxystannate, glass flakes, glass spheres, polymeric spheres, fibers, aluminum hydroxide, antimony oxide, boron phosphate, fumed silica, and combinations of any thereof. Examples of suitable inorganic fibers include carbide fibers such as silicon carbide fibers, boron carbide fibers, and niobium carbide fibers; nitride fibers such as silicon nitride fibers; boron-containing fibers such as boron fibers and boride fibers; silicon-containing fibers such as silicon fibers; alumina-boron-silica fibers; E-glass fibers; C-glass fibers; A-glass fibers; S-glass fibers; mineral-glass fibers; magnesia alumosilicate fibers; quartz fibers; silica fibers; alumina fibers; alumosilicate fibers; aluminum silicate fibers; magnesia alumosilicate fibers; soda borosilicate fibers; soda silicate fibers; polycarbosilane fibers; polytitanocarbosilane fibers; polysilazane fibers; wollastonite fibers; potassium aluminum silicate fibers; metal fibers such as iron fibers, aluminum fibers, steel fibers, and zinc fibers; carbon fibers such as pure carbon fibers, graphite fibers, slagwool fibers, and charcoal fibers; rockwool fibers such as pure rockwool fibers and basalt rockwool fibers; processed mineral fibers from mineral wool; attapulgite fibers; and combinations of any thereof.

As described above, the intumescent coating composition can comprise a thermosetting binder resin and a curing agent formulated in separate packs that are mixed together before application onto a substrate. For example, the intumescent coating composition can comprise a first pack comprising the binder resin(s) (i.e., the binder component (A)) and a second pack comprising the curing agent(s) (i.e., the curing agent component (B)). The carbon donor compound(s), the acid-generating agent(s), the expansion agent(s), and any of the above-described optional or auxiliary components (e.g., reactive diluent(s), amine-functional expansion agent(s), accelerator compound(s), inorganic nucleating agent(s), rheology modifier(s), inorganic filler particle(s), char reinforcing agent(s), flame retardant(s), liquid carrier(s), colorant(s), and the like), can be formulated in the binder component (A), or the curing agent component (B), or both components (A) and (B).

The intumescent coating composition can be applied directly to a surface of a substrate to be protected or over a primer coating or other underlying coating layer. The intumescent coating composition can be a liquid at ambient temperatures (e.g., at −10 to 50° C.), whether formulated as a solvent-based composition, a water-based composition, or a 100% solids composition that does not comprise a volatile solvent or aqueous carrier. The intumescent coating composition can therefore be applied onto substrates by techniques such as spraying or brushing. The intumescent coating composition can be formulated with a liquid viscosity that is suitable for atomization and droplet formation under the high shear conditions associated with single or multiple component airless spray application techniques between −10 and 60° C. Thus, the present invention includes a method for protecting a substrate from fire and/or heat, the method comprising applying the intumescent coating composition described in this specification over at least a portion of the substrate surface.

The intumescent coating composition may be applied on various substrates to form cured or otherwise solidified intumescent coatings. The intumescent coating composition is particularly suitable for application on metal substrates, for example, steel and aluminum substrates, and composite materials, for example, glass reinforced plastic (GRP). Due to the combination of excellent strength and thermal protection provided by the char produced by the resulting intumescent coating upon fire exposure, the intumescent coating compositions can be used to protect structures from cellulosic fires and hydrocarbon fires. Thus, the present invention includes a coated substrate comprising an intumescent coating applied over at least a portion of the substrate surface, wherein the intumescent coating is produced using the intumescent coating composition described in this specification. When applied to a substrate, the dry film thickness of the intumescent coating layer can range, for example, from 0.1 to 50 millimeters, or any sub-range subsumed therein, such as, for example, 1-25 mm, 1-15 mm, 2-10, or 2-5 mm.

### WORKING EXAMPLES

The following working examples are intended to further describe the invention. It is understood that the invention described in this specification is not necessarily limited to the examples described in this section.

### Example 1: Preparation of an Expansion Agent Powder Comprising an Addition Polymer of a 1,1-Di-Carbonyl Vinyl Compound

Diethyl methylene malonate (DEMM) was added to an unlined steel can using a high density polyethylene pipette and chilled in an ice-water bath. Dimethyl-ethanolamine (DMEA) was added dropwise to the cooled DEMM, accompanied by gentle swirling of the combined contents in the can. The DMEA was added to the DEMM at an amount equal to 1 percent based on the total mass of the DEMM and DMEA. An exothermic polymerization of the DEMM occurred rapidly and the entire reaction mixture converted into a solid mass (polyDEMM) in the can. The solid product was allowed to equilibrate to room temperature overnight.

The solid mass of polyDEMM was chiseled out of the can and ground into a coarse powder using a commercial blender (Black & Decker). The coarse powder was introduced into an Air Classification Mill and further ground until the average particle size of the polyDEMM expansion agent powder was 35-40 micrometers.

### Example 2: TGA-MS of the polyDEMM Expansion Agent Powder of Example 1

The polyDEMM expansion agent powder produced according to Example 1 was analyzed by thermogravimetric analysis/mass spectrometry (TGA-MS) using a Q50 thermogravimetric analyzer (available from TA Instruments) equipped with a Pfeiffer ThermoStar MS mass-spectrometer (available from Pfeiffer Vacuum GmbH). The purge gas was ultra high purity helium with a flowrate of 100 milliliters-per-minute. A one hour purge was performed before analysis and data collection. The heating rate for each sample was 10° C./minute. The mass spectrometry data was collected first as a trend scan to determine the specific atomic mass units of the decomposition products. A single analysis run was performed per each 20 milligram sample of the polyDEMM expansion agent powder. A total of 200 milligrams of the polyDEMM expansion agent powder was analyzed.

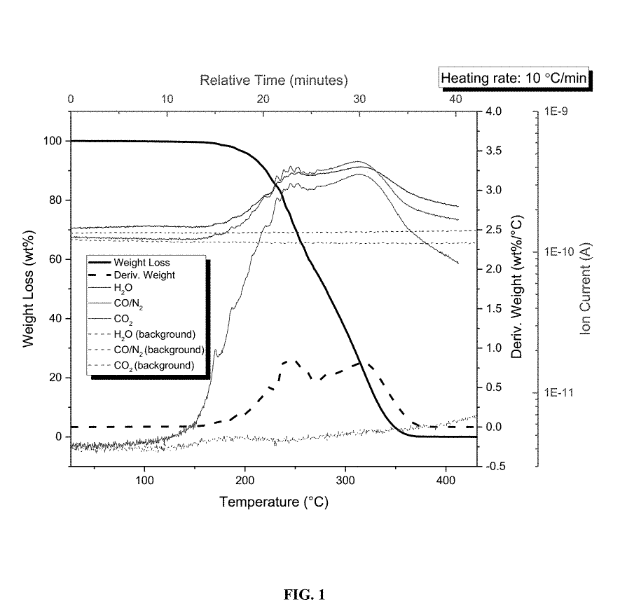

A plot of representative TGA-MS data for the polyDEMM expansion agent powder is shown in FIG. 1. The data confirms that carbon dioxide is released when the polyDEMM expansion agent powder is heated to decomposition. Decomposition temperatures were designated as the temperatures of the derivative weight peaks, where multiple peaks indicate multiple decomposition events. Decomposition started at about 150° C. and peaked at 225° C., 245° C., and 315° C.

### Example 3: Preparation of an Intumescent Coating Composition Comprising the polyDEMM Expansion Agent Powder of Example 1

A two-component (i.e., two-pack) 100% solids formulation that did not comprise a solvent or an aqueous carrier was formulated using the components listed in Table 1.

TABLE 1

| | | | |
|---|---|---|---|
| | | Inventive | Comparative |
| | | Example | Example |
| | | (weight | (weight |
| No. | Component | percentage) | percentage) |

A-pack (Binder Component)

| | | | |
|---|---|---|---|
| 1 | Epoxy resin | 11.72 | 11.63 |
| 2 | Epoxy reactive diluent | 4.23 | 4.19 |
| 3 | Titanium dioxide | 7.37 | 8.66 |
| 4 | Pentaerythritol | 7.37 | 8.66 |
| 5 | Accelerant compound | 2.80 | 2.78 |
| 6 | Ammonium polyphosphate | 15.50 | 12.65 |

B-pack (Curing Agent Component)

| | | | |
|---|---|---|---|
| 7 | Amino resin | 19.56 | 16.68 |
| 8 | Amino reactive diluent | 2.72 | 2.32 |
| 9 | polyDEMM | 10.28 | |
| 10 | Ammonium polyphosphate | 18.44 | 32.44 |
| | Total | 100.00 | 100.00 |

1. EPON Resin 828, a di-functional bisphenol A/epichlorhydrin derived liquid epoxy resin, available from Hexion Inc.
2. Epodil ® 749, neopentyl glycol diglycidyl ether, available from Air Products and Chemicals, Inc./Evonik Industries AG.
3. Nucleating agent/pigment.
4. Carbon donor compound.
5. Benzyl alcohol.
6. Acid-generating agent.
7. Versamid ® 150, a reactive polyamide resin based on dimerized fatty acids and polyamines, available from Gabriel Phenoxies Inc.
8. Isophorone diamine.
9. The polyDEMM expansion agent powder produced according to Example 1.
10. Acid-generating agent.

### Example 4: Burn Test of Intumescent Coatings Formed from the Intumescent Coating Composition of Example 3

The inventive example and the comparative example according to Example 3 were each applied to separate pre-primed steel panels using 80 mils bird type film applicators. The A-pack (binder component) and the B-pack (curing agent component) were mixed together and immediately applied as wet films over the panels by draw down using the bird type film applicators. The films were dried for a week at room temperature and the dry film thicknesses of each film were measured. After measurement of the dry film thicknesses, each panel was exposed to a blowtorch for 3 minutes placed at a distance of 14 centimeters and at an angle of 90° from the panels. The thickness of the resulting char was measured and the expansion factor was calculated by dividing the char thickness by the dry film thickness before flame exposure.

The inventive example exhibited an expansion factor of 20, and the comparative example exhibited an expansion factor of 10. In other words, the intumescent coating of the inventive example exhibited a 20× thickness expansion, and the comparative example exhibited a 10× thickness expansion, in the resulting foamed char.

### ASPECTS OF THE INVENTION

Aspects of the invention include, but are not limited to, the following numbered clauses.

1. An intumescent coating composition comprising:

a binder resin;

an acid-generating agent; and

an expansion agent comprising meso-lactide, polylactide, a polysulfone, a polycarbonate, a polyester, a 1,1-di-activated vinyl compound, or an addition polymer of a 1,1-di-activated vinyl compound, or a combination of any thereof.

2. The intumescent coating composition of clause 1, further comprising a carbon donor compound.
3. The intumescent coating composition of clause 2, wherein the carbon donor compound comprises an organic polyhydroxy compound.
4. The intumescent coating composition of clause 2 or clause 3, wherein the carbon donor compound comprises pentaerythritol, dipentaerythritol, tripentaerythritol, starch, cellulose, or a sugar, or a combination of any thereof.
5. The intumescent coating composition of any one of clauses 2-4, wherein the carbon donor compound comprises pentaerythritol.
6. The intumescent coating composition of any one of clauses 1-5, wherein the expansion agent comprises an addition polymer of a 1,1-di-carbonyl vinyl compound.
7. The intumescent coating composition of clause 6, wherein the expansion agent comprises an addition polymer of:

a dialkyl methylene malonate;

a diaryl methylene malonate;

a multifunctional form of a dialkyl methylene malonate; or

a multifunctional form of a diaryl methylene malonate; or

a combination of any thereof.

8. The intumescent coating composition of clause 7, wherein the expansion agent comprises an addition polymer of:

dimethyl methylene malonate;

a multifunctional form of dimethyl methylene malonate;

diethyl methylene malonate; or

a multifunctional form of diethyl methylene malonate; or

a combination of any thereof.

9. The intumescent coating composition of clause 8, wherein the expansion agent comprises an addition polymer of diethyl methylene malonate.
10. The intumescent coating composition of any one of clauses 1-9, wherein the expansion agent comprises polylactide.
11. The intumescent coating composition of any one of clauses 1-10, wherein the expansion agent comprises particles of the expansion agent.
12. The intumescent coating composition of clause 11, wherein the expansion agent particles have an average particle size of 10-100 micrometers.
13. The intumescent coating composition of clause 12, wherein the expansion agent particles have an average particle size of 25-50 micrometers.
14. The intumescent coating composition of any one of clauses 1-13, wherein the acid-generating agent comprises a phosphoric acid ester of a polyhydroxy compound, an ammonium phosphate, or an amine phosphate.
15. The intumescent coating composition of clause 14, wherein the acid-generating agent comprises ammonium polyphosphate (APP).
16. The intumescent coating composition of any one of clauses 1-15, wherein the coating composition comprises a 100% solids formulation that does not comprise a solvent or aqueous carrier.
17. The intumescent coating composition of clause 16, further comprising a reactive diluent.
18. The intumescent coating composition of any one of clauses 1-17, wherein the binder resin comprises an epoxy-functional resin.
19. The intumescent coating composition of any one of clauses 1-18, further comprising an amino-functional curing agent.
20. The intumescent coating composition of clause 19, wherein the amino-functional curing agent comprises a polyamide resin.
21. The intumescent coating composition of any one of clauses 1-20, further comprising a melamine compound.
22. The intumescent coating composition of any one of clauses 1-20, wherein the coating composition does not comprise melamine compounds.
23. A two-component intumescent coating composition comprising:

(A) a binder component comprising a polymeric epoxy-functional binder resin; and

(B) a curing agent component comprising:
an amino-functional resin; and
an expansion agent comprising particles of an addition polymer of a 1,1-di-carbonyl vinyl compound;

wherein component (A), or component (B), or both components (A) and (B), further comprise an acid-generating agent; and

wherein the coating composition comprises a 100% solids formulation that does not comprise a solvent or an aqueous carrier.

24. The intumescent coating composition of clause 23, wherein component (A) further comprises a carbon donor compound.
25. The intumescent coating composition of clause 24, wherein the carbon donor compound comprises pentaerythritol, dipentaerythritol, tripentaerythritol, starch, cellulose, or a sugar, or a combination of any thereof.
26. The intumescent coating composition of any one of clauses 1-25, wherein the expansion agent comprises an addition polymer of diethyl methylene malonate, an addition polymer of dimethyl methylene malonate, or an addition copolymer of diethyl methylene malonate and dimethyl methylene malonate, or a combination of any thereof.
27. The intumescent coating composition of any one of clauses 23-26, wherein the acid-generating agent comprises ammonium polyphosphate (APP).
28. The intumescent coating composition of any one of clauses 23-27, wherein the amino-functional resin comprises a polyamide resin.
29. The intumescent coating composition of any one of clauses 23-28, wherein:

component (A) further comprises a reactive diluent comprising a di-functional epoxy compound; and

component (B) further comprises a reactive diluent comprising a di-functional amino compound.

30. The intumescent coating composition of clause 29, wherein the di-functional epoxy compound comprises neopentyl glycol diglycidyl ether; and wherein the di-functional amino compound comprises isophorone diamine.
31. The intumescent coating composition of any one of clauses 23-30, further comprising a melamine compound.
32. The intumescent coating composition of any one of clauses 23-30, wherein the coating composition does not comprise melamine compounds.
33. A method for protecting a substrate from fire and/or heat, the method comprising applying the intumescent coating composition of any one of clauses 1-32 over at least a portion of the substrate surface.
34. A coated substrate comprising an intumescent coating applied over at least a portion of the substrate surface, wherein the intumescent coating is produced using the intumescent coating composition of any one of clauses 1-32.

Various features and characteristics are described in this specification to provide an understanding of the composition, structure, production, function, and/or operation of the invention, which includes the disclosed compositions, coatings, and methods. It is understood that the various features and characteristics of the invention described in this specification can be combined in any suitable manner, regardless of whether such features and characteristics are expressly described in combination in this specification. The Inventors and the Applicant expressly intend such combinations of features and characteristics to be included within the scope of the invention described in this specification. As such, the claims can be amended to recite, in any combination, any features and characteristics expressly or inherently described in, or otherwise expressly or inherently supported by, this specification. Furthermore, the Applicant reserves the right to amend the claims to affirmatively disclaim features and characteristics that may be present in the prior art, even if those features and characteristics are not expressly described in this specification. Therefore, any such amendments will not add new matter to the specification or claims, and will comply with written description, sufficiency of description, and added matter requirements, including the requirements under 35 U.S.C. § 112(a) and Article 123(2) EPC.

Any numerical range recited in this specification describes all sub-ranges of the same numerical precision (i.e., having the same number of specified digits) subsumed within the recited range. For example, a recited range of “1.0 to 10.0” describes all sub-ranges between (and including) the recited minimum value of 1.0 and the recited maximum value of 10.0, such as, for example, “2.4 to 7.6,” even if the range of “2.4 to 7.6” is not expressly recited in the text of the specification. Accordingly, the Applicant reserves the right to amend this specification, including the claims, to expressly recite any sub-range of the same numerical precision subsumed within the ranges expressly recited in this specification. All such ranges are inherently described in this specification such that amending to expressly recite any such sub-ranges will comply with written description, sufficiency of description, and added matter requirements, including the requirements under 35 U.S.C. § 112(a) and Article 123(2) EPC. Also, unless expressly specified or otherwise required by context, all numerical parameters described in this specification (such as those expressing values, ranges, amounts, percentages, and the like) may be read as if prefaced by the word “about,” even if the word “about” does not expressly appear before a number. Additionally, numerical parameters described in this specification should be construed in light of the number of reported significant digits, numerical precision, and by applying ordinary rounding techniques. It is also understood that numerical parameters described in this specification will necessarily possess the inherent variability characteristic of the underlying measurement techniques used to determine the numerical value of the parameter.

The invention(s) described in this specification can comprise, consist of, or consist essentially of the various features and characteristics described in this specification. The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. Thus, a composition, coating, or method that “comprises,” “has,” “includes,” or “contains” one or more features and/or characteristics possesses those one or more features and/or characteristics, but is not limited to possessing only those one or more features and/or characteristics. Likewise, an element of a composition, coating, or process that “comprises,” “has,” “includes,” or “contains” one or more features and/or characteristics possesses those one or more features and/or characteristics, but is not limited to possessing only those one or more features and/or characteristics, and may possess additional features and/or characteristics.

The grammatical articles “a,” “an,” and “the,” as used in this specification, including the claims, are intended to include “at least one” or “one or more”, unless otherwise indicated. Thus, the articles are used in this specification to refer to one or more than one (i.e., to “at least one”) of the grammatical objects of the article. By way of example, “a component” means one or more components, and thus, possibly, more than one component is contemplated and can be employed or used in an implementation of the described compositions, coatings, and processes. Nevertheless, it is understood that use of the terms “at least one” or “one or more” in some instances, but not others, will not result in any interpretation where failure to use the terms limits objects of the grammatical articles “a,” “an,” and “the” to just one. Further, the use of a singular noun includes the plural, and the use of a plural noun includes the singular, unless the context of the usage requires otherwise.

Any patent, publication, or other document identified in this specification is incorporated by reference into this specification in its entirety unless otherwise indicated, but only to the extent that the incorporated material does not conflict with existing descriptions, definitions, statements, illustrations, or other disclosure material expressly set forth in this specification. As such, and to the extent necessary, the express disclosure as set forth in this specification supersedes any conflicting material incorporated by reference. Any material, or portion thereof, that is incorporated by reference into this specification, but which conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference. The amendment of this specification to add such incorporated subject matter will comply with written description, sufficiency of description, and added matter requirements, including the requirements under 35 U.S.C. § 112(a) and Article 123(2) EPC.

What is claimed is:

1. An intumescent coating composition comprising:
a binder resin;
an acid-generating agent; and
an expansion agent comprising meso-lactide, polylactide, a polysulfone, a polycarbonate, a polyester, a 1,1-di-activated vinyl compound, or an addition polymer of a 1,1-di-activated vinyl compound, or a combination of any thereof.

2. The intumescent coating composition of claim 1, further comprising a carbon donor compound.

3. The intumescent coating composition of claim 2, wherein the carbon donor compound comprises an organic polyhydroxy compound.

4. The intumescent coating composition of claim 2, wherein the carbon donor compound comprises pentaerythritol, dipentaerythritol, tripentaerythritol, starch, cellulose, or a sugar, or a combination of any thereof.

5. The intumescent coating composition of claim 2, wherein the carbon donor compound comprises pentaerythritol.

6. The intumescent coating composition of claim 1, wherein the expansion agent comprises an addition polymer of a 1,1-di-carbonyl vinyl compound.

7. The intumescent coating composition of claim 6, wherein the expansion agent comprises an addition polymer of:
a dialkyl methylene malonate;
a diaryl methylene malonate;
a multifunctional form of a dialkyl methylene malonate; or
a multifunctional form of a diaryl methylene malonate; or
a combination of any thereof.

8. The intumescent coating composition of claim 7, wherein the expansion agent comprises an addition polymer of:
dimethyl methylene malonate;
a multifunctional form of dimethyl methylene malonate;
diethyl methylene malonate; or
a multifunctional form of diethyl methylene malonate; or
a combination of any thereof.

9. The intumescent coating composition of claim 8, wherein the expansion agent comprises an addition polymer of diethyl methylene malonate.

10. The intumescent coating composition of claim 1, wherein the expansion agent comprises polylactide.

11. The intumescent coating composition of claim 1, wherein the expansion agent comprises particles of the expansion agent.

12. The intumescent coating composition of claim 11, wherein the expansion agent particles have an average particle size of 10-100 micrometers.

13. The intumescent coating composition of claim 12, wherein the expansion agent particles have an average particle size of 25-50 micrometers.

14. The intumescent coating composition of claim 1, wherein the acid-generating agent comprises a phosphoric acid ester of a polyhydroxy compound, an ammonium phosphate, or an amine phosphate.

15. The intumescent coating composition of claim 14, wherein the acid-generating agent comprises ammonium polyphosphate (APP).

16. The intumescent coating composition of claim 1, wherein the coating composition comprises a 100% solids formulation that does not comprise a solvent or aqueous carrier.

17. The intumescent coating composition of claim 16, further comprising a reactive diluent.

18. The intumescent coating composition of claim 1, wherein the binder resin comprises an epoxy-functional resin.

19. The intumescent coating composition of claim 18, further comprising an amino-functional curing agent.

20. The intumescent coating composition of claim 19, wherein the amino-functional curing agent comprises a polyamide resin.

21. The intumescent coating composition of claim 1, further comprising a melamine compound.

22. The intumescent coating composition of claim 1, wherein the coating composition does not comprise melamine compounds.

23. A two-component intumescent coating composition comprising:
(A) a binder component comprising an epoxy-functional binder resin; and
(B) a curing agent component comprising:
an amino-functional resin; and
an expansion agent comprising particles of an addition polymer of a 1,1-di-carbonyl vinyl compound;
wherein component (A), or component (B), or both components (A) and (B), further comprise an acid-generating agent; and
wherein the coating composition comprises a 100% solids formulation that does not comprise a solvent or an aqueous carrier.

24. The intumescent coating composition of claim 23, wherein component (A) further comprises a carbon donor compound.

25. The intumescent coating composition of claim 24, wherein the carbon donor compound comprises pentaerythritol, dipentaerythritol, tripentaerythritol, starch, cellulose, or a sugar, or a combination of any thereof.

26. The intumescent coating composition of claim 23, wherein the expansion agent comprises an addition polymer of diethyl methylene malonate, an addition polymer of dimethyl methylene malonate, or an addition copolymer of diethyl methylene malonate and dimethyl methylene malonate, or a combination of any thereof.

27. The intumescent coating composition of claim 23, wherein the acid-generating agent comprises ammonium polyphosphate (APP).

28. The intumescent coating composition of claim 23, wherein the amino-functional resin comprises a polyamide resin.

29. The intumescent coating composition of claim 23, wherein:
component (A) further comprises a reactive diluent comprising a di-functional epoxy compound; and
component (B) further comprises a reactive diluent comprising a di-functional amino compound.

30. The intumescent coating composition of claim 29, wherein the di-functional epoxy compound comprises neopentyl glycol diglycidyl ether; and wherein the di-functional amino compound comprises isophorone diamine.

31. The intumescent coating composition of claim 23, further comprising a melamine compound.

32. The intumescent coating composition of claim 23, wherein the coating composition does not comprise melamine compounds.

33. A method for protecting a substrate from fire and/or heat, the method comprising applying the intumescent coating composition of claim 1 over at least a portion of the substrate surface.

34. A coated substrate comprising an intumescent coating applied over at least a portion of the substrate surface, wherein the intumescent coating is produced using the intumescent coating composition of claim 1.
